(19) United States
(12) Patent Application Publication
(10) Pub. No.: US 2009/0192870 A1
(43) Pub. Date: Jul. 30, 2009

(54) SYSTEM AND METHOD FOR MONITORING CONSUMPTION OF MARKETING CONTENT

(75) Inventors: SCOTT WHITE, Austin, TX (US); James L. Cansler, Pflugerville, TX (US); Charles Scott, Austin, TX (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., RENO, NV (US)

(21) Appl. No.: 12/021,754

(22) Filed: Jan. 29, 2008

(51) Int. Cl. G06Q 30/00; G06Q 50/00

(52) U.S. Cl. 705/10

(57) ABSTRACT

A system that incorporates teachings of the present disclosure may include, for example, a monitoring system having a controller to receive a consumption notice indicating whether marketing content supplied by a media communication system to a media processor has been properly consumed by the media processor according to a presentation time indicator associated with the marketing content. Other embodiments are disclosed.

### FIELD OF THE DISCLOSURE

The present disclosure relates generally to marketing techniques and more specifically to a system and method for monitoring consumption of marketing content.

### BACKGROUND

Some media processors such as set-top boxes can provide consumers a means to record media programs such as TV programming, streaming media from the Internet, and radio programs for later consumption. Some media processors can also record or buffer media content so that consumers can pause live media programs and return to them at their convenience. In one or both instances, the media processor can present the consumer a number of functions such as pause, scene selection, fast forward, fast rewind, and so on to manage the presentation of the recorded media program.

### BRIEF DESCRIPTION OF THE DRAWINGS

FIGS. 1-4 depict exemplary embodiments of communication systems that provide media services;

FIG. 5 depicts an exemplary embodiment of a portal interacting with at least one among the communication systems of FIGS. 1-4;

FIG. 6 depicts an exemplary method operating in portions of the communication systems of FIGS. 1-4; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a computer-readable storage medium in a media processor having computer instructions for recording a media program and marketing content supplied by a media communication system, receiving from the media communication system a presentation time indicator associated with the marketing content, and determining whether action is taken to avoid a presentation of the marketing content according to the presentation time indicator.

Another embodiment of the present disclosure entails a monitoring system having a controller to receive a consumption notice indicating whether marketing content supplied by a media communication system to a media processor has been properly consumed by the media processor according to a presentation time indicator associated with the marketing content.

Yet another embodiment of the present disclosure entails a method involving monitoring a consumption of marketing content by a plurality of media processors according to a presentation time indicator supplied to the plurality of media processors.

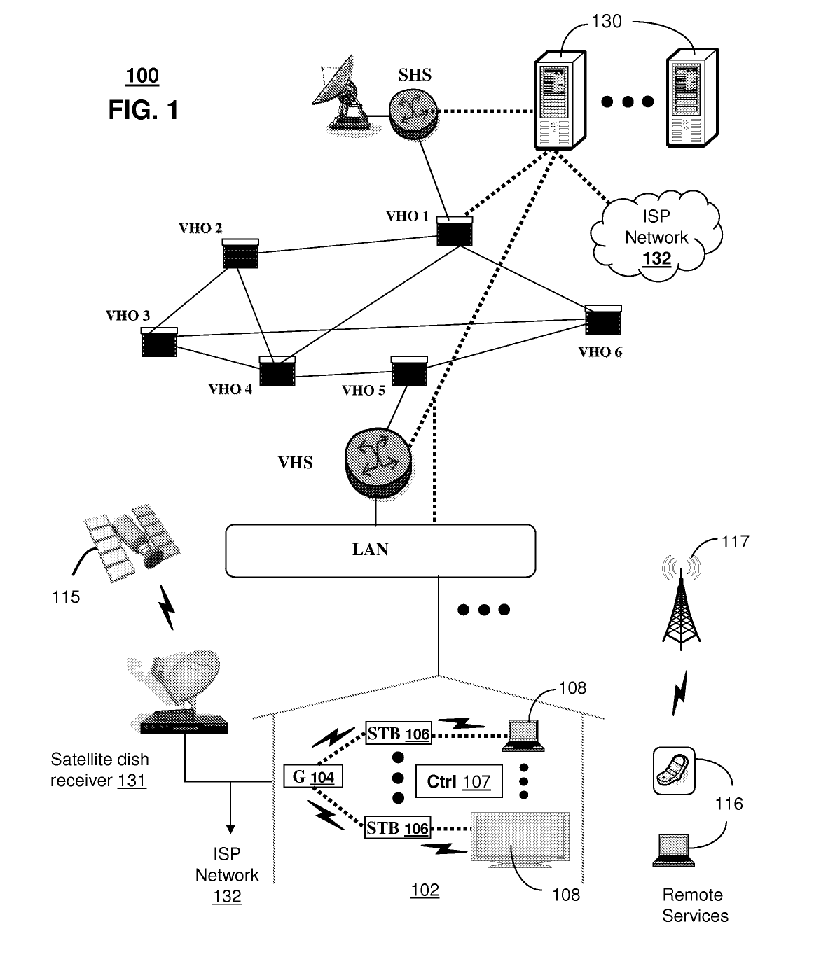

FIG. 1 depicts an exemplary embodiment of a first communication system 100 for delivering media content. The communication system 100 can represent an IPTV broadcast media system. In a typical IPTV infrastructure, there is at least one super head-end office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as Set-Top Boxes (STBs) which in turn present broadcast selections to media devices 108 such as computers or television sets managed in some instances by a media controller 107 (e.g., an infrared or RF remote control). Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and present multicast or unicast media content.

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.). Another distinct portion of the one or more computing devices 130 can be used as a monitoring system 130 that monitors consumption behavior of marketing content supplied by the first communication system 100 to media processors.

A satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems such as cable TV systems.

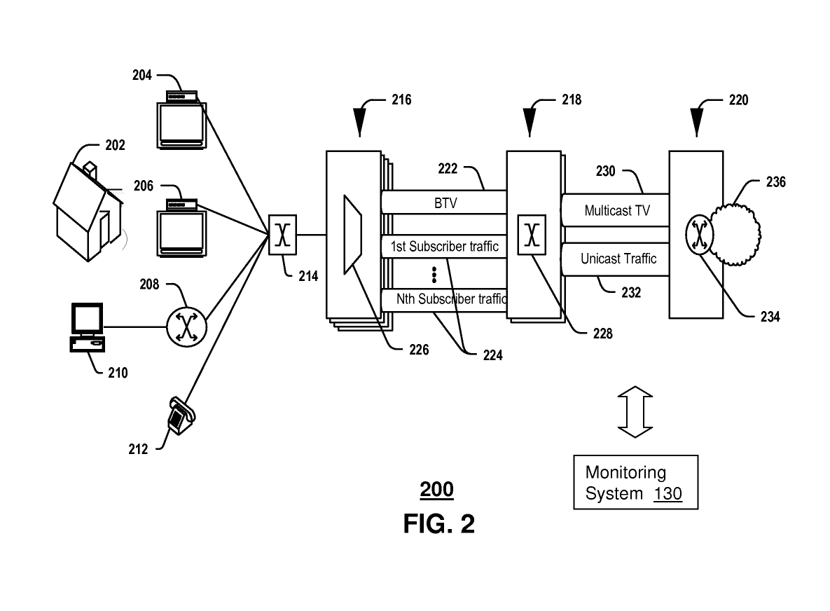

FIG. 2 depicts an exemplary embodiment of a second communication system 200 for delivering media content. Communication system 200 can be overlaid or operably coupled with communication system 100 as another representative embodiment of said communication system. The system 200 includes a distribution switch/router system 228 at a central office 218. The distribution switch/router system 228 receives video data via a multicast television stream 230 from a second distribution switch/router 234 at an intermediate office 220. The multicast television stream 230 includes Internet Protocol (IP) data packets addressed to a multicast IP address associated with a television channel. The distribution switch/router system 228 can cache data associated with each television channel received from the intermediate office 220.

The distribution switch/router system 228 also receives unicast data traffic from the intermediate office 220 via a unicast traffic stream 232. The unicast traffic stream 232 includes data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, receives a channel change command from an input device, such as a remoter control device. The channel change command can indicate selection of an IPTV channel. After receiving the channel change command, the set-top box device 204 generates channel selection data that indicates the selection of the IPTV channel. The set-top box device 204 can send the channel selection data to the access switch/router system 226 via the residential gateway 214. The channel selection data can include an Internet Group Management Protocol (IGMP) Join request. In an illustrative embodiment, the access switch/router system 226 can identify whether it is joined to a multicast group associated with the requested channel based on information in the IGMP Join request.

If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

The monitoring system 130 of FIG. 1 can be operably coupled to the second communication system 200 for purposes of monitoring consumption behavior of marketing content by subscribers of the second communication system.

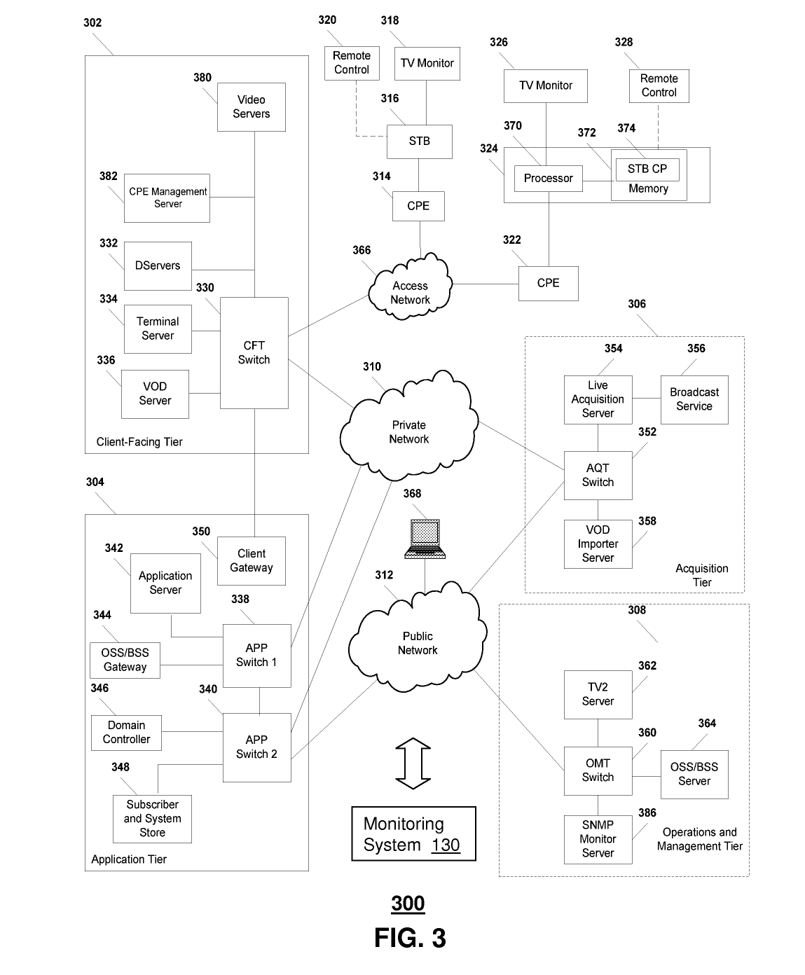

FIG. 3 depicts an exemplary embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 is coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 322.

As illustrated in FIG. 3, the various tiers 302, 304, 306, 308 communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an exemplary embodiment, the client-facing tier 302 can be coupled to the CPE 314, 322 via fiber optic cables. In another exemplary embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a video-on-demand (VOD) server 336 that stores or provides VOD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VOD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VOD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VOD server 336 at the client-facing tier 302 via the private network 310. Additionally, at the acquisition tier 306, the video-on-demand (VOD) importer server 358 can receive content from one or more VOD sources outside the IPTV system 300, such as movie studios and programmers of non-live content. The VOD importer server 358 can transmit the VOD content to the AQT switch 352, and the AQT switch 352, in turn, can communicate the material to the CFT switch 330 via the private network 310. The VOD content can be stored at one or more servers, such as the VOD server 336.

When users issue requests for VOD content via the set-top box devices 316, 324, the requests can be transmitted over the access network 366 to the VOD server 336, via the CFT switch 330. Upon receiving such requests, the VOD server 336 can retrieve the requested VOD content and transmit the content to the set-top box devices 316, 324 across the access network 366, via the CFT switch 330. The set-top box devices 316, 324 can transmit the VOD content to the television monitors 318, 326. In an illustrative embodiment, video or audio portions of VOD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

The monitoring system 130 of FIGS. 1-2 can be operably coupled to the third communication system 300 for purposes of monitoring consumption behavior of marketing content by subscribers of the third communication system.

It should be apparent to one of ordinary skill in the art from the foregoing media communication system embodiments that other suitable media communication systems for distributing broadcast media content as well as peer-to-peer exchange of content can be applied to the present disclosure.

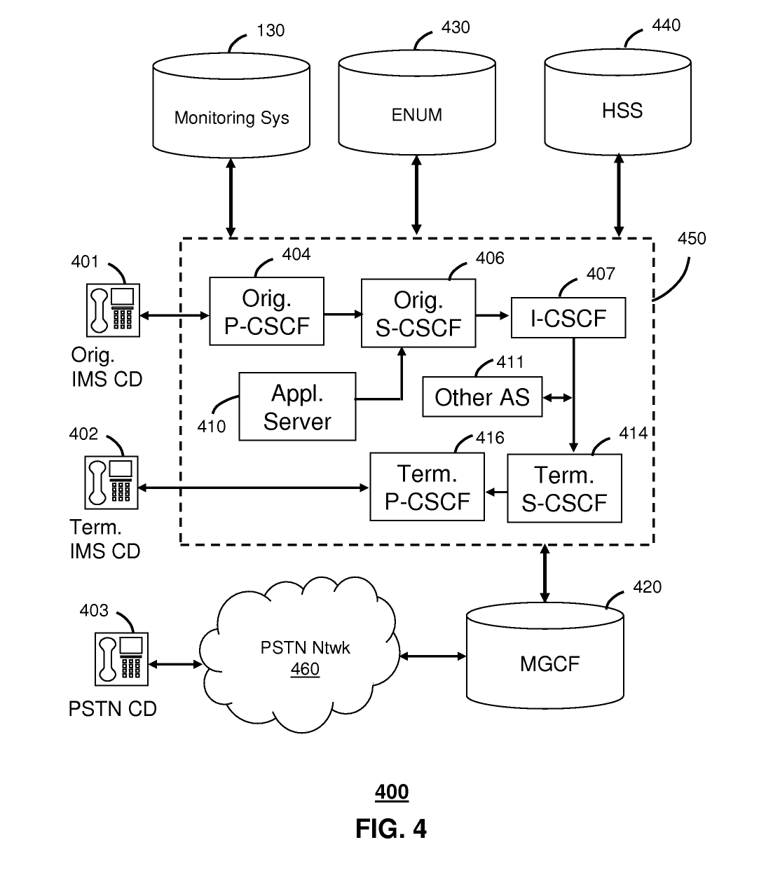

FIG. 4 depicts an exemplary embodiment of a communication system 400 employing a IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) support by the HSS 440. To accomplish a communication session between CDs, an originating IMS CD 401 can submit a SIP INVITE message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E.164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (not shown).

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process is symmetrical. Accordingly, the terms “originating” and “terminating” in FIG. 4 can be interchanged.

IMS network 450 can also be operably coupled to the monitoring system 130 previously discussed for FIG. 1. In this representative embodiment, the monitoring system 130 can be accessed over a PSTN or VoIP channel of communication system 400 by common techniques such as described above.

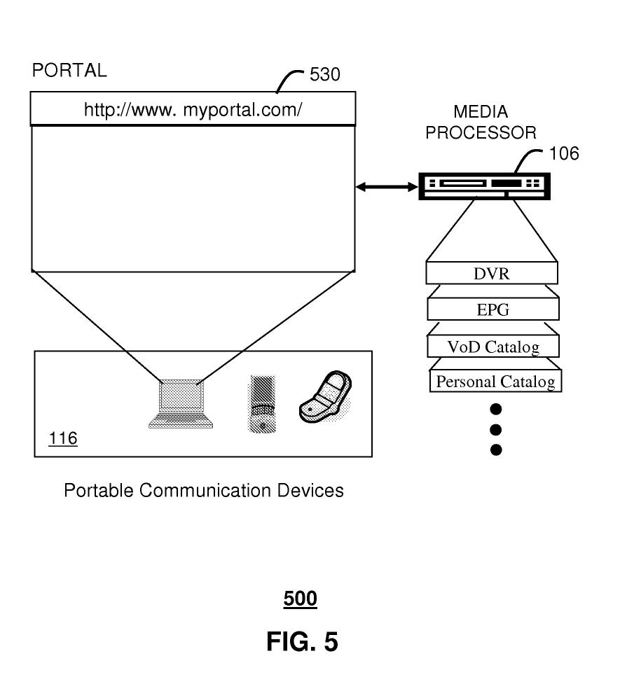

FIG. 5 depicts an exemplary embodiment of a portal 530. The portal 530 can be used for managing services of communication systems 100-400. The portal 530 can be accessed by a Uniform Resource Locator (URL) with a common Internet browser such as Microsoft's Internet Explorer using an Internet-capable communication device such as references 108, 116, or 210 of FIGS. 1-2. The portal 530 can be configured to access a media processor such as references 106, 204, 206, 316, and 324 of FIGS. 1-3 and services managed thereby such as a Digital Video Recorder (DVR), an Electronic Programming Guide (EPG), VOD catalog, a personal catalog stored in the STB (e.g., personal videos, pictures, audio recordings, etc.), and so on.

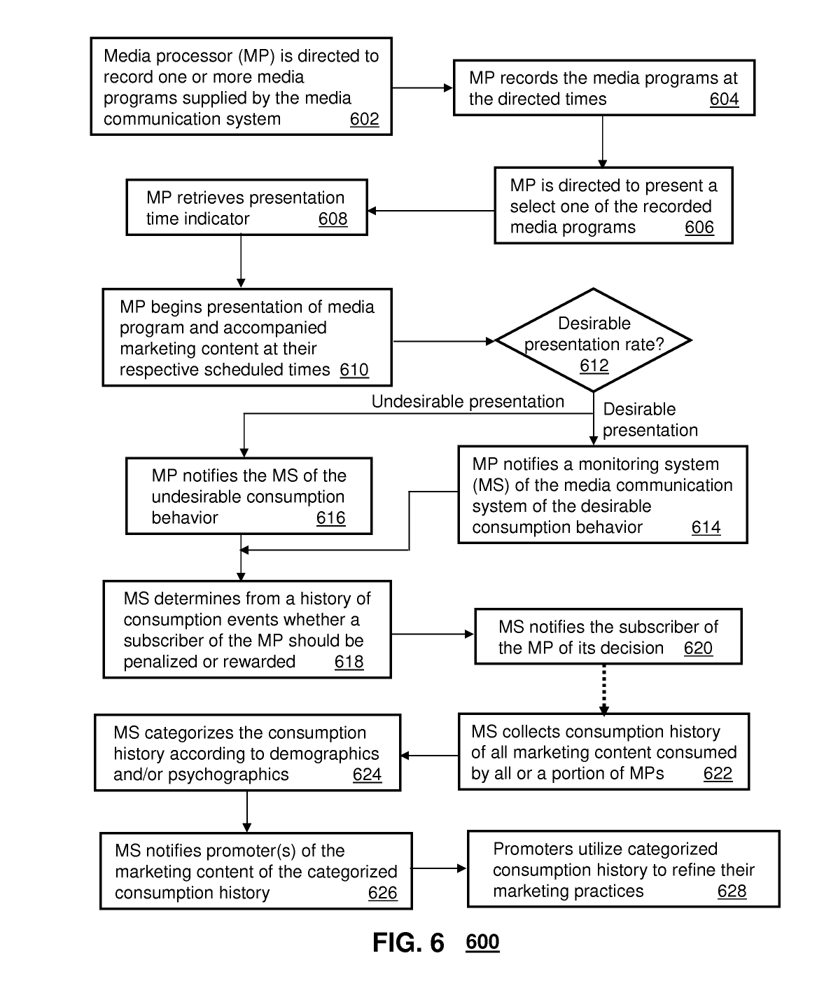

FIG. 6 depicts an exemplary method 600 operating in portions of communication systems 100-400. Method 600 begins with step 602 in which a user of a media processor (e.g., STB, DVR, STB coupled to DVR, DVR integrated in STB, etc.) is directed to record one or more media programs supplied by the media communication system of FIGS. 1-4. This step can represent for example DVR settings which are used by the media processor to record in step 604 TV programs at the directed times. The TV programs can be intermixed with marketing content (e.g., advertisements). In another illustrative embodiment, step 604 can represent VoD media programs which are downloaded from the media communication system to the media processor. Some of the downloaded programs may be TV programs, or movies with intermixed marketing content (e.g., advertisements, movie previous, etc.). This step can also represent the recording of radio broadcasts supplied by the media communication system which can also be intermixed with marketing content. In yet another illustrative embodiment, step 604 can represent a media processor that records or buffers live media programs of any format responsive to a user of the media processor requesting a pause of the media program.

Accordingly, steps 602-604 can represent the provisioning of the media processor to record any form of media content (audio content, still image content, moving image content) supplied by the media communication system at any point in time.

In step 606, the media processor can be directed to present a select one of the recorded media programs. This step can be triggered by a selection made by a user of the media processor of one of the recorded media programs or removal by the user of a pause request previously applied to a specific live media program. The selection can trigger the generation of a common graphical user interface (GUI) with play, fast forward, rewind, pause, skip, scene selection, and other common functions to control the presentation of the recorded media program. In response to the user's request to begin play back of a select media program, the media processor can retrieve in step 608 a presentation time indicator associated with the recorded media program.

The presentation time indicator can provide among other things a duration for the media program and at least an estimation of start and end times for marketing content intermixed with the media program. The presentation time indicator can be determined by the media communication system and supplied to the media processor in an electronic programming guide (EPG) or some other suitable delivery method. In another illustrative embodiment, the presentation time indicator can be supplied to the media processor as metadata embedded with the media program that was recorded.

For legacy media communication systems that don't currently provide delineable time markers for marketing content in an EPG or as metadata, said systems can be updated to provide such markers upon request by the media processor, or as a database of the media communication system which is accessible by the media processor. The service provider of legacy media communication systems can identify when the marketing content is to be presented, or can work in cooperation with the promoters of the media program and corresponding marketing content to identify at least an estimation of start and end times for the marketing content. In another illustrative embodiment, the monitoring system 130 previously described for FIGS. 1-4 can be used to determine the presentation time indicator for marketing content in each media program of an EPG, and supply said information when needed to a media processor.

Once the presentation time indicator has been retrieved by the media processor by any of the aforementioned techniques, the media processor can proceed to step 610 where it begins the presentation of the media program accompanied by the marketing content at its scheduled times. During the presentation, the media processor can monitor in step 612 whether the presentation of the marketing content occurs at a desirable presentation rate. The desirable presentation rate can represent for example a rate of presentation that indicates the user of the media processor is not proactively accelerating the presentation of the marketing content using common functions such as skip, fast forward, etc. to circumvent its presentation.

If the media processor detects that a select marketing content item has been presented at an expected presentation rate, the media processor proceeds to step 614 once the presentation is complete and notifies the monitoring system 130 that a desirable consumption behavior for the monitored marketing content item has been detected, which the monitoring system then records. The detection of an expected presentation rate can be determined by the media processor according to the estimated start and end times of the marketing content along with a knowledge of the media program duration. The notification can identify for example which media program the marketing content was presented with along with an identification of the marketing content item itself. The media processor can determine this from the presentation time indicator retrieved in step 608.

Suppose for example that the media processor is informed by way of the presentation time indicator that a media program has a duration of 1 hour intermixed with 4 marketing content items (each item can represent promotions, advertisements, previews, etc.). Each marketing content item can be delineated by a start time and duration or end time. For instance item 1 can have a start time of 10 minutes after the media program has started and a duration of 5 minutes, item 2 can start 25 minutes after the start of the media program with a duration of 5 minutes, item 3 can start 40 minutes after the start of the media program with a duration of 5 minutes, and item 4 can start 55 minutes after the start of the media program with a duration of 3 minutes. In this illustration, the media program has a total presentation time of 42 minutes, while the collective marketing content items 1-4 have a presentation time of 18 minutes. With time markers such as these, the media processor can readily determine if the user has performed any task or action that circumvents a regular presentation of the marketing content.

Referring back to step 612, if the media processor detects an accelerated presentation rate (e.g., fast forward, or skip function applied to the recorded marketing content), the media processor can proceed to step 616 where it notifies the monitoring system 130 that an undesirable consumption behavior for a select marketing content item has been detected. As before, the media processor can identify in the notice the media program and the marketing content that was improperly consumed, which the monitoring system 130 records. From a history of consumption behavior of marketing content recorded for the media processor, the monitoring system 130 can determine in step 618 whether the subscriber of the media processor should be penalized or rewarded. Once a determination is made, the monitoring system 130 can notify in step 620 the subscriber of its decision by way of the media processor.

The service provider of the media communication system can utilize any a reward and penalization techniques that is suitable to its business objectives. For example, in step 618, the service provider can utilize a system whereby for each notification of a desirable consumption, the subscriber is given merit points, while for each notification of an undesirable consumption, the subscriber is given demerits points which diminish merit points. The service provider can then establish reward versus penalty thresholds which can be applied the cumulative points (i.e., sum of merit and demerit points). If for example a history of consumption behavior (desirable and undesirable) leads to a cumulative score above the reward threshold, the monitoring system 130 can be directed to reward the subscriber.

If on the other hand the cumulative score falls below the penalty threshold, the monitoring system 130 can be directed to penalize the subscriber. Once the subscriber is rewarded or penalized, the monitoring system 130 can reset the consumption history and start over. More complex techniques that apply for example statistical algorithms (e.g., linear regression) can be used to determine or predict consumption behavior of the subscriber of the media processor which can be compared to reward and penalty criteria by the service provider.

The service provider of the media communication system can also establish any suitable reward or penalty that influences the behavior of its subscribers. For example, a subscriber can be rewarded by the service provider with a reduction in fees charged to the subscriber by the media communication system, a coupon for discounting a purchase of media content supplied by the media communication system, and a free-of-charge offer of select media content supplied by the media communication system, and so on. The service provider can for example penalize a subscriber by increasing fees charged to the subscriber by the media communication system. Other forms of awards and penalties can be applied to the present disclosure.

A subscriber can use portal 530 to monitor its standing with the service provider in regards to for example its cumulative score and rewards or penalties applied by the service provider. The portal 530 can also serve as a means to select award items, record disputes by the subscriber in regards to a penalty, and so forth.

Steps 622-626 which follow can be applied collectively to all media processors operating in the media communication system. In step 622, for example, the monitoring system 130 can collect the consumption behavioral history as described above for all marketing content consumed by all or a portion the media processors in the media communication system. The monitoring system 130 can then categorize in step 624 the consumption behavioral history of each marketing content item according to demographic and/or psychographic categories determined from subscriber data of the subscribers of the corresponding media processors being monitored.

For example, consumption behaviors (desirable and undesirable) for a select marketing content item can be categorized demographically by gender, age, race, location, income, employment status, and so on, of the subscribers who consumed said item. Similarly the consumption behavior for the same marketing content item can be categorized psychographically by personality, values, attitudes, interests, lifestyles and so on which can be determined in part by the type of media programs consumed by the subscribers and the services the subscribers have procured from the media communication system.

Categorized consumption behavioral information such as this can then be presented in step 626 by the monitoring system 130 to promoters of the corresponding marketing content. The promoters can in turn utilize this information in step 628 to improve and/or refine their marketing practices. In some instances, this can mean that the promoters update the marketing content, and/or selectively target only certain types of media programs consumed by select demographic and/or psychographic groups of subscribers. In other instances, step 628 can represent a decision on the part of some promoters to discontinue certain marketing content, and/or to replace it with other forms of marketing content that can more readily target subscribers of interest.

Upon reviewing the aforementioned embodiments, it would be evident to an artisan with ordinary skill in the art that said embodiments can be modified, reduced, or enhanced without departing from the scope and spirit of the claims described below. For example, method 600 can be adapted so that notification takes place on a collective basis for a group of marketing content items intermixed with a specific media program. In this illustrative embodiment, the media processor can be directed to collect the consumption behavior of multiple marketing content items before it notifies the monitoring system 130 of its findings. This form of notification can be more efficient than notifying the monitoring system 130 one marketing content item at a time, thereby reducing network congestion. In another illustrative embodiment, the method 600 can be adapted to notify the monitoring system 130 of consumption behavior during non-peak hours (e.g., 12 am-3:30 am). This can also help to reduce network congestion.

Other suitable modifications that can be applied to the present disclosure without departing from the scope of the claims below. Accordingly, the reader is directed to the claims section for a fuller understanding of the breadth and scope of the present disclosure.

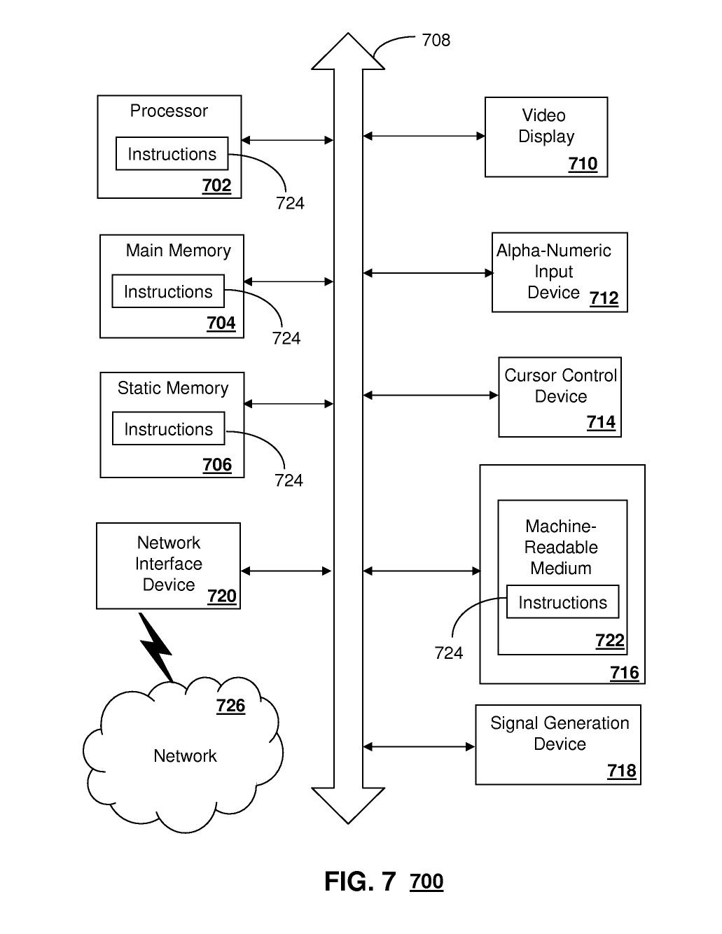

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a media processor, comprising computer instructions for:
recording a media program and marketing content supplied by a media communication system;
receiving from the media communication system a presentation time indicator associated with the marketing content; and
determining whether action is taken to avoid a presentation of the marketing content according to the presentation time indicator.

2. The storage medium of claim 1, wherein the media processor comprises one among a digital video recorder (DVR), a set-top box (STB) coupled to a DVR, and an STB with an integrated DVR, wherein the marketing content corresponds to one or more advertisements, and wherein the media communication system corresponds to at least one among an Internet Protocol Television (IPTV) communication system, a cable TV communication system, a satellite TV communication system, a Public Switched Telephone Network (PSTN), a Voice over IP (VoIP) communication system, and an IP Multimedia Subsystem (IMS) combining the PSTN and VoIP communication systems.

3. The storage medium of claim 1, comprising computer instructions for:
detecting a desired consumption behavior of the marketing content based on the media processor presenting the marketing content at an expected presentation rate; and
submitting a notice to the media communication system of the desired consumption behavior.

4. The storage medium of claim 3, wherein the media communication system records the detected desired consumption behavior and determines from a frequency of previous consumption events recorded for the media processor whether a subscriber of the media processor merits an award.

5. The storage medium of claim 3, comprising computer instructions for:
receiving from the media communication system an award responsive to the submitted notice; and
presenting the award to a subscriber of the media processor.

6. The storage medium of claim 4, wherein the award comprises at least one among a reduction in fees charged by the media communication system, a coupon for discounting a purchase of media content supplied by the media communication system, and a free-of-charge offer of select media content supplied by the media communication system.

7. The storage medium of claim 6, wherein media content comprises at least one among audio content, still image content, and moving image content.

8. The storage medium of claim 1, comprising computer instructions for:
detecting an undesirable consumption behavior of the marketing content; and
submitting a notice to the media communication system of the undesirable consumption behavior.

9. The storage medium of claim 8, comprising computer instructions for detecting the undesirable consumption behavior based on the media processor presenting the marketing content at an accelerated presentation rate.

10. The storage medium of claim 8, wherein the media communication system records the undesirable consumption behavior and determines from a frequency of previous consumption events recorded for the media processor whether a subscriber of the media processor should incur a penalty.

11. The storage medium of claim 10, wherein the penalty corresponds to an increase in fees charged by the media communication system to the subscriber.

12. The storage medium of claim 1, wherein the presentation time indicator corresponds to metadata supplied by the media communication system.

13. The storage medium of claim 1, wherein the presentation time indicator comprises at least an estimation of start and end times for a presentation of the marketing content relative to a presentation time of the media program, and an identification of the marketing content.

14. A monitoring system, comprising a controller to receive a consumption notice indicating whether marketing content supplied by a media communication system to a media processor has been properly consumed by the media processor according to a presentation time indicator associated with the marketing content.

15. The monitoring system of claim 14, wherein the controller is adapted to:
determine the presentation time indicator from an intermixed presentation of a media program and the marketing content; and
transmit the presentation time indicator to the media processor.

16. The monitoring system of claim 15, wherein the presentation time indicator corresponds to metadata supplied with the media program.

17. The monitoring system of claim 14, wherein the controller is adapted to receive the consumption notice from the media processor.

18. The monitoring system of claim 14, wherein the consumption notice comprises one among a desirable consumption indicator, and an undesirable consumption indicator.

19. The monitoring system of claim 14, wherein the controller is adapted to record the consumption notice and determine from a history of recorded consumption notices whether to award or penalize a subscriber of the media processor.

20. The monitoring system of claim 14, wherein the controller is adapted to:
reward a subscriber of the media processor responsive to detecting a desired consumption behavior of the marketing content based on the media processor presenting the marketing content at an expected presentation rate; and
penalize the subscriber responsive to detecting an undesirable consumption behavior of the marketing content based on the media processor presenting the marketing content at an accelerated presentation rate.

21. The monitoring system of claim 20, wherein the subscriber is rewarded with at least one among a reduction in fees charged to the subscriber by the media communication system, a coupon for discounting a purchase of media content supplied by the media communication system, and a free-of-charge offer of select media content supplied by the media communication system; wherein the subscriber is penalized with an increase in fees charged to the subscriber by the media communication system; wherein the media processor comprises one among a digital video recorder (DVR), a set-top box (STB) coupled to a DVR, and an STB with an integrated DVR, wherein the marketing content corresponds to one or more advertisements, and wherein the media communication system corresponds to at least one among an Internet Protocol Television (IPTV) communication system, a cable TV communication system, a satellite TV communication system, a Public Switched Telephone Network (PSTN), a Voice over IP (VoIP) communication system, and an IP Multimedia Subsystem (IMS) combining the PSTN and VoIP communication systems.

22. A method, comprising monitoring a consumption of marketing content by a plurality of media processors according to a presentation time indicator supplied to the plurality of media processors.

23. The method of claim 22, comprising:
rewarding a subscriber of one of the plurality of media processors responsive to detecting a desired consumption behavior of the marketing content based on the media processor presenting the marketing content at an expected presentation rate determined according to the presentation time indicator; and
penalizing the subscriber responsive to detecting an undesirable consumption behavior of the marketing content based on the media processor presenting the marketing content at an accelerated presentation rate determined according to the presentation time indicator.

24. The method of claim 22, comprising:
collecting from each of the plurality of media processors a history of consumption behavior of the marketing content;
categorizing the history of consumption behavior according to at least one among a demographic category and a psychographic category determined from subscriber data of a plurality of subscribers of the monitored plurality of media processors; and
submitting to a promoter of the marketing content the categorized history of consumption behavior of the marketing content.

25. The method of claim 24, wherein the media processor comprises one among a digital video recorder (DVR), a set-top box (STB) coupled to a DVR, and an STB with an integrated DVR, wherein the marketing content corresponds to one or more advertisements, and wherein the media processor operates in a media communication system, and wherein the media communication system corresponds to at least one among an Internet Protocol Television (IPTV) communication system, a cable TV communication system, a satellite TV communication system, a Public Switched Telephone Network (PSTN), a Voice over IP (VoIP) communication system, and an IP Multimedia Subsystem (IMS) combining the PSTN and VoIP communication systems, and wherein the method comprises the promoter utilizing the categorized history of consumption behavior to update its marketing practices.
